(19) United States
(12) Patent Application Publication
(10) Pub. No.: US 2007/0200820 A1
(43) Pub. Date: Aug. 30, 2007

(54) Terminal For Navigating Documents

(75) Inventors: Filip Svensson, Malmo (SE); Oscar Fogelberg, Malmo (SE)

Correspondence Address: BIRCH STEWART KOLASCH & BIRCH, PO BOX 747, FALLS CHURCH, VA, 22040-0747, US

(73) Assignee: OBIGO AB, Lund (SE)

(21) Appl. No.: 10/594,673

(22) PCT Filed: Mar. 31, 2005
(86) PCT No.: PCT/SE05/00462

§ 371 Date: Apr. 18, 2007

(30) Foreign Application Priority Data
Apr. 1, 2004 (SE) 0400875-1

(51) Int. Cl. G09G 5/00

(52) U.S. Cl. 345/156

(57) ABSTRACT

A terminal for navigating documents, comprising browser means (1), pointer means (2) arranged to be controlled by a terminal user, a small-size display (3), and display means (4) arranged to display a portion of a large-size document on the small-size display (3), the area of the complete large-size document being larger than the area of the small-size display (3). The terminal comprises control means (5) arranged to form a miniature copy of the complete large-size document browsed by the browser means (1), and the display means (4) are arranged to display the miniature copy on the small-size display (3) in the form of a miniature field (6).

### TECHNICAL FIELD

The present invention relates to a terminal for navigating documents, comprising browser means, pointer means arranged to be controlled by a terminal user, a small-size display, and display means arranged to display a portion of a large-size document on the small-size display, the area of the complete large-size document being larger than the area of the small-size display.

### BACKGROUND OF THE INVENTION

Mobile communication terminals such as mobile phones are becoming more powerful making it possible to process the same amount of data with a mobile phone as with a traditional PC. Instead of just displaying short text messages via SMS containing only a couple of hundreds of characters, the mobile phones of today can display word processing documents, spreadsheets, large web pages etc. However, even though the mobile phones can process a large amount of data, the size of the display of the mobile phones is limited making it hard for the user to overview and find information in large-size documents. When browsing a large web page, for example, on a small-size display, it is hard to find a specific spot in the web page. Further, if the user has scrolled for a while in the web page, it is hard for the user to keep track on his position in the web page.

These problems also exist for so called smart mobile phones. These smart mobile phones have larger displays compared to traditional mobile phones. The display is usually a touch screen, and the user uses a stylus to tap on the touch screen in more or less the same manner as a mouse is used on a PC. These smart mobile phones are powerful, i.e. having large memory and powerful processors, and therefore it is possible to load the same web pages into the web browser on the mobile phone as is loaded into the web browser in a PC. However, although the display on smart mobile phones is large compared to traditional mobile phones, the display is still regarded as small when browsing conventional web pages. It is hard to navigate around on the web page and get an overview of the entire web page.

Therefore, there is a need for a technique which gives the user a good overview of a large-size document, and at the same time makes it possible to navigate and scroll easily to any position in the large-size document. Further, it is desirable that said technique does not result in a big change of the original way to display a large-size document.

U.S. Pat. No. 6,466,203 B2 discloses a handheld communication device provided with a display with touch screen, the device having a browser and being capable of retrieving a web page from the Internet. The web page is first displayed in its entirety. The user can recognize the web page's general layout and presence of hyperlinks. When the user touches a particular location on the touch screen that corresponds to a portion of the web page's image, the portion gets displayed so as to fill the display's area. Thus, the user can browse a web page with a display of limited size.

US 2003/0137522 A1 discloses how web pages are displayed with a simultaneous overview and magnified view. An indicator can show the portion of the overview in the magnified view. Both views can be shown, one above the other, across the full width of the same screen. A user can select between such a split view and another view, including an overview, a magnified-only view, and a view in which selected text is laid out to fit the width of the magnified view.

U.S. Pat. No. 6,590,583 B2 discloses a method for digital image magnification in a graphical user interface. The method provides a method for magnification that allows simultaneous viewing of the magnified image and its unmagnified context. The method provides a floating window superimposed on the original image. Displayed within the floating window is a magnified image of a selected region of the original image. In one aspect of the method the floating window is transparent.

WO 03/034342 A1 discloses a magnifying tool enlarging a selected region of displayed image surrounding a cursor in a graphical user interface, and superimposes the enlarged region directly over the selected region. The location of the cursor relative to the enlarged region is co-located with the location of the cursor relative to the selected region such that the locations are identical.

US 2002/0143826 A1 discloses a web browser which magnifies the content of the whole web page in a memory and displays the relevant portion in a magnifier with hyperlinks. The browser then maps the magnified display to the original document. Thus, manipulation of the mouse in the magnified display may result in an action with respect to the original document. The user may then select a link for navigation within the magnified display.

WO 02/082418 A2 discloses a method for the display of standardised pages, generated for display on large-size screen, on a small display on handheld devices. A virtual large image memory is maintained in the device. Within the large virtual image the device display can be freely displayed as a readable image section. A zoom function permits an overview and coarse positioning of the detailed representation. The detailed representation can be continuously moved around within the virtual image in the form of a screen section by means of a pointer device by moving the pointer to the display edge. Switch can be performed at any time between the display modes.

However, above mentioned devices and methods do not provide a satisfactory way to browse large-size documents on a handheld communication terminal with a small-size display which provides a good overview of the entire large-size document and at the same time makes it possible to navigate and scroll easily to any position in said large-size document.

### SUMMARY OF THE INVENTION

The object of the present invention is to provide a device having a small-size display, providing a good overview of a large-size document which is too large to be displayed in its entirety on the small-size display, and a user-friendly method of navigation of large-size documents.

The above mentioned object is achieved by providing a terminal which provides a radical improvement of navigating documents by a terminal of the kind defined in the preamble of claim 1, comprising the special features that the terminal comprises control means arranged to form a miniature copy of the complete large-size document browsed by the browser means, and that the display means are arranged to display the miniature copy on the small-size display or screen in the form of a miniature field. Preferably, the miniature field is movable on the small-size display and is superimposed on the displayed portion of the large-size document. With this terminal according to the present invention a good overview of large-size documents is provided enabling for the terminal user to see his current position in the large-size document being browsed. The browser means of the terminal according to the present invention can be any kind of browser capable of browsing large-size documents, e.g. a browser using the method Smart Rendering.

According to an advantageous embodiment of the terminal according to the present invention, the display means are arranged to display the miniature copy in such a way that the ratio between the width and height of the miniature copy is equal to the ratio between the width and height of the complete large-size document.

According to a further advantageous embodiment of the terminal according to the present invention, the pointer means are arranged to point at any position in the miniature field, that the control means are arranged to register the position pointed by the pointer means, and that the display means are arranged to display on the small-size display the position, i.e. area, in the large-size document corresponding to the position pointed by the pointer means.

The pointer means can comprise a stylus combined with a touch screen or a joystick, a scroll wheel, a set of buttons, a tilt sensor or the like.

As an alternative the pointer means can comprise a voice controlled arrangement, such that the user can move the pointer means in the miniature field by saying e.g. “up”, “left”, etc.

It is also possible to accomplish a remote controlled arrangement where e.g. a person talking with the user over the phone can be allowed to move the pointer during the conversation in order to show the user different features in the document.

With this embodiment an effective and user-friendly method of navigation of a large-size document is provided. Preferably, the size of the miniature field is adjustable.

According to another advantageous embodiment of the terminal according to the present invention, the miniature field is scrollable.

According to an advantageous embodiment of the terminal according to the present invention, the control means are arranged to position a displayed position field in the miniature field in such a way that the position of the position field in the miniature copy corresponds to the position of the displayed portion of the large-size document in said large-size document, i.e. the position field is positioned in the miniature copy as the displayed portion of the large-size document is positioned in said large-size document. The position field is displayed in such a way that it is contrasting to the miniature field, for example having a certain colour. This embodiment of the terminal enables for the user to see his precise current position in the large-size document being browsed. Preferably, the display means are arranged to display the position field in such a way that the ratio between the width and height of the position field is equal to the ratio between the width and height of the displayed portion of the large-size document.

According to a further advantageous embodiment of the terminal according to the present invention, the control means are arranged to move the position field to any other position in the miniature copy by means of the pointer means, that the control means are arranged to register the new position of the position field, and that the display means are arranged to display on the small-size display the portion of the large-size document corresponding to the new position of the position field. With these further features of this embodiment an even more effective and user-friendly method of navigation of a large-size document is provided.

According to another advantageous embodiment of the terminal according to the present invention, the display means are arranged to display the miniature field and position field, respectively, on the small-size display with different transparency levels. This feature allows for the user to be able see through the miniature field and view the whole displayed portion of the large-size document. Preferably, the display means are arranged to display the portion of the large-size document on the small-size display in such a way that the area of said displayed portion is equal or almost equal to the area of the small-size display.

According to yet another advantageous embodiment of the terminal according to the present invention, the small-size display is a touch screen. Preferably, the terminal is a telecommunication device, preferably handheld, for example a mobile phone, and the browser means of the terminal according to the invention are arranged to browse web pages on Internet, or any type of documents, for example word processing documents, spreadsheets, web pages, web documents, large images etc.

### BRIEF DESCRIPTION OF THE DRAWINGS

The present invention will now be described, for exemplary purposes, in more details by way of embodiments and with reference to the enclosed drawings, in which:

FIG. 1 is a schematic view of a terminal according to the present invention, and

FIG. 2 is a schematic view of the positioning of the position field and miniature field in relation to the displayed portion of a large-size document and said large-size document.

### DETAILED DESCRIPTION OF EMBODIMENTS

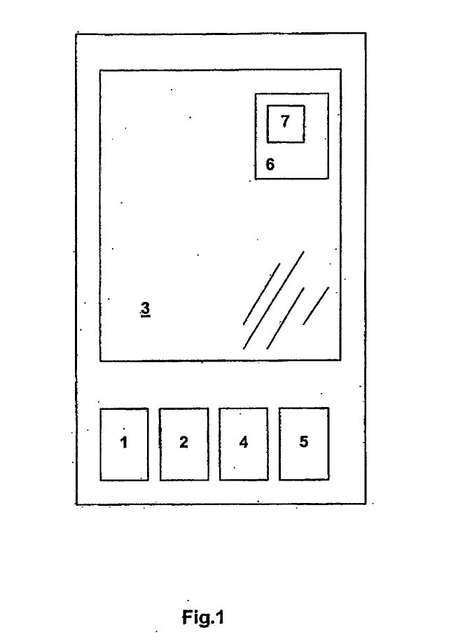

FIG. 1 shows a handheld telecommunication terminal for navigating documents according to the present invention, comprising browser means 1, pointer means 2 arranged to be controlled by a terminal user, a small-size display 3 with touch screen, and display means 4 arranged to display a portion of a large-size document on the small-size display 3, the area of said displayed portion being equal to the area of the small-size display 3, and the area of the complete large-size document being larger than the area of the small-size display 3. The terminal comprises control means 5 arranged to form a miniature copy of the complete large-size document browsed by the browser means 1, and the display means 4 are arranged to display the miniature copy on the small-size display 3 in the form of a movable size-adjustable miniature field 6. Further, the control means 5 are arranged to position a displayed position field 7 in the miniature field 6 in such a way that the position of the position field 7 in the miniature copy corresponds to the position of the displayed portion of the large-size document in said large-size document, the display means 4 being arranged to display the position field 7 in such a way that the position field 7 is contrasting to the miniature field 6.

The display means 4 may be arranged to display the miniature field 6 and position field 7, respectively, on the small-size display 3 with different transparency levels.

By a transparency level is meant to what extent the other contents of the small-sized display 3 are visible to the user in the area where the miniature and position fields 6, 7 are displayed. If the transparency level is zero, other contents are not visible at all in the area where the miniature and position fields 6, 7 are displayed. If instead the transparency level is at a maximum, instead the miniature and position fields 6, 7 are not visible at all. In transparency levels between those extremes the miniature and position fields 6, 7 are displayed together with other content in a “double exposure” fashion.

Preferably the transparency levels of the miniature and position fields 6, 7 are variable during use. Thus, in one embodiment, the user may set the transparency level to a preferred value.

In an alternative embodiment, the transparency level may vary in accordance with actions taken by the user. When e.g. the user changes the position of the position field 7 in the miniature field 6 the transparency level may rapidly become low so that the miniature and position fields 6, 7 become more clearly visible. When sub-sequently the user stops moving the position field 7, the transparency level may be increased so that the miniature and position fields fade away to a certain extent, or totally, thus making other contents more clearly visible in that area of the small-sized display.

Thus the transparency level of the miniature field may be depending on the amount of time that has passed since the last pointer means input, such that the transparency level is low when the pointer means is used and the increases (step-wise or continuously) when the pointer means is no longer used.

The display means 4 are arranged to display the miniature copy in such a way that the ratio between the width and height of the miniature copy is equal to the ratio between the width and height of the complete large-size document. Further, the miniature field 6 is scrollable. The miniature field 6 being scrollable is suitable for large-size documents that are very high but not wide, in which case the miniature copy would more or less be a thin line on the small-size display 3, and to avoid this problem the miniature field 6 is scrollable. When the control means 5 form the miniature copy, said control means 5 make the miniature copy at least x pixels wide. By doing so, the miniature copy might become higher than what is appropriate to display and therefore, and instead of displaying the complete miniature copy the miniature field 6 becomes scrollable. The same applies for documents that are very wide and not high.

The terminal is arranged to navigate a large-size document in the two following ways. Firstly, the pointer means 2, comprising a stylus, are arranged to point at any position in the miniature field 6, and the control means 5 are arranged to register the position pointed by the pointer means 2. The display means 4 are arranged to display in the small-size display 3 the area of that position in the large-size document corresponding to the position pointed by the pointer means 2. Secondly, the control means 5 are arranged to move the position field 7 to any other position within the miniature copy by means of the pointer means 2. The control means 5 are arranged to register the new position of the position field 7, and the display means 4 are arranged to display on the small-size display 3 the portion of the large-size document corresponding to the new position of the position field 6.

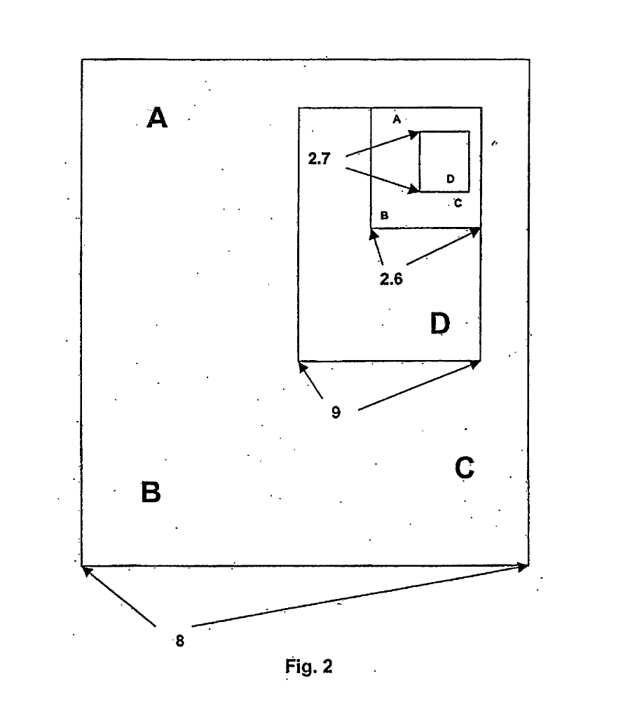

FIG. 2 schematically shows how the terminal according to the invention displays a portion of a large-size document, a miniature field displaying the complete miniature copy, and a position field, in relation to each other and to the large-size document itself. FIG. 2 shows a schematic view of a complete large-size document 8, a displayed portion 9 of said large-size document 8 being displayed on the small-size display of the terminal according to the invention, the area of said displayed portion 9 being equal to the area of the small-size display, a displayed miniature field 2.6 in which a complete miniature copy of the complete large-size document is displayed, and a position field 2.7 displayed in the miniature field 2.6 and positioned in such a way that the position of the position field 2.7 in the miniature copy corresponds to the position of the displayed portion 9 of the large-size document 8 in said large-size document 8. The display means of the terminal are arranged to display the miniature copy and position field 2.7 in such a way that the ratio between the width and height of the miniature copy is equal to the ratio between the width and height of the complete large-size document 8, and the ratio between the width and height of the position field 2.7 is equal to the ratio between the width and height of the displayed portion 9 of the large-size document 8.

The size of the miniature field 6 may be adjustable. Having an adjustable size of the miniature field 6 makes it possible for the user to choose a personal trade off between readability of the miniature field 6 and visibility of the displayed portion 9 of the large size document.

The adjustability can be done while retaining the height and width proportions of the miniature field 6, i.e. the user may adjust the size using only one degree of freedom by dragging a corner along a diagonal of the same, or e.g. by rotating a scroll wheel.

The control means 5 should then be arranged to adjust the size of the position field in such a way that the relative proportions of the miniature field 6 and the position field 7 are retained.

The displayed portion 9 of the large size document 8 can be displayed with different degrees of magnification. By displaying the displayed portion 9 of the large size document 8 with a magnification larger than one, the effective size (measured in pixels of the large size document) of the small-size display will be decreased. Accordingly, if the magnification is less than one, the effective size will be increased. If a magnification that differs from one is used, the relative proportions of the miniature field 6 and the position field 7 should show the proportions of the large size document 8 and the effective size of the small-size display 3.

Inversely, if the user adjusts the relative proportions of the miniature field 6 and the position field 7 e.g by dragging a corner of the position field 7 along a diagonal of the same, the magnification used by the display means 4 should be adjusted accordingly.

When using a magnification that differs from one, the display means 4 may have to use interpolation to display the relevant parts of the large size document 8.

As mentioned above, the terminal according to the invention provides two different types of navigation. Firstly, the terminal user can navigate to any position in the complete large-size document 8 with only one tap with the stylus in the miniature field 2.6. For example, if the user taps on position X₁, Y₁ in the miniature copy, the browser means will scroll the displayed portion 9 of the large-size document 8 in such a way that the position X₂, Y₂ in the large-size document 8 is displayed in the upper left corner of the displayed portion 9 of the large-size document 8. The relation between X₁, Y₁ and X₂, Y₂ (X₁, Y₁ having its origin in the upper left corner of the miniature copy and X₂, Y₂ having its origin in the upper left corner of the complete large-size document) is:

$${X}_{2} = \frac{{X}_{1}}{width ( miniature copy )} * width ( large \text{-} size document )$$

$${Y}_{2} = \frac{{Y}_{1}}{height ( miniature copy )} * height ( large \text{-} size document )$$

Secondly, the terminal user can navigate by moving the position field 2.7 in a dragging way with the stylus. The position field 2.7 can be moved to any position in the miniature copy. By moving the position field 2.7 x₁Dif, y₁Dif pixels, the displayed portion 9 of the large-size document 8 will be scrolled x₂Dif, y₂Dif pixels. The relation between x₁Dif, y₁Dif and x₂Dif, y₂Dif is:

$${x}_{2} Dif = \frac{{x}_{1} Dif}{width ( miniature copy )} * width ( large \text{-} size document )$$

$${y}_{2} Dif = \frac{{y}_{1} Dif}{height ( miniature copy )} * height ( large \text{-} size document )$$

The pointer means 2 can as mentioned comprise a stylus combined with a touch screen. However, other alternatives are possible.

A joystick can be used if the terminal comprises such a device. The position of the position field 7 in the miniature field 6 (and correspondingly the position of the displayed portion 9 in the large size document 8) can then be controlled by pushing the joystick in different directions. Of course, a set of buttons can provide the same function. If the terminal comprises a tilt sensor the position of the position field 7 in the miniature field 6 can instead be controlled in a corresponding manner by tilting the terminal in different directions.

As yet another alternative a scroll wheel can be used. In one mode the scroll wheel can control the vertical position of the position field 7 in the miniature field 6. In a second mode, that can be selected e.g. by pushing the scroll wheel, rotating the scroll wheel can instead change the horizontal position of the position field 7 in the miniature field 6.

As an alternative the pointer means can comprise a voice controlled arrangement, such that the user can move the pointer means in the miniature field by saying e.g. “up”, “left”, etc.

It is also possible to accomplish a remote controlled arrangement where e.g. a person talking with the user over the phone can be allowed to move the pointer during the conversation in order to show the user different features in the document. In general that persons terminal then provides control information similar to the information provided by the pointer means 2.

The control means 5 may perform a number of different tasks;

1) Receive a request for scroll.

2) Receive a request for change of the size of the miniature field 6.

3) Receive a request for change of the size of the position field 7, with a corresponding change of the magnification.

4) Move the position field 7 within the miniature field 6, change the size of the miniature field and/or change the size of the position field in accordance with the request.

5) Propose a move of position field 7 within the miniature field 6, a change of the size of the miniature field 6 and/or a change of the size of the position field 7 that is approximately according to the request. The approximation may consist in that the movement and/or the magnification proposed are chosen to better fit the actual content of the large size document, for example, by showing a column of text with its entire width displayed on the small-size display.

The proposed position field may be shown to the user as blinking before it is accepted by the user.

6) Show a number of available positions and/or magnifications that are chosen by the control means with regard to the content of the large size document. The available positions may be immediately attainable by for example dedicated buttons.

7) Send information on the position and/or the magnification to the display means.

The requests may be supplied by the pointer means.

It is not necessary to display a pointer. The visible response to i.e. a scroll request may be only the movement of the position field within the miniature field and/or the corresponding change of which part of the large size document that is shown on the small-size display.

The miniature field 2.6 and the position field 2.7, respectively, can as mentioned above be displayed with different transparency levels. The transparency level can be set by the terminal user and is configurable within the range of no transparency to full transparency. If half transparency is set, the terminal user can see the displayed portion 9 of the large-size document 8 partly through the miniature field 2.6. The miniature field 2.6 and the position field 2.7 can have different degrees of transparency, e.g. the miniature field 2.6 can be half transparent and the position field 2.7 can be fully transparent.

The miniature field 2.6 can be moved to any place on the small-size display, and can be moved so that most of the area of the miniature field 2.7 is positioned outside the small-size display and hence not visible. The only restriction is that some area of the miniature field 2.6 still is positioned within the small-size display.

The invention is not restricted to the described embodiment. It may be varied within the scope of the appended claims.

1. A terminal for navigating documents, comprising: browser means;
pointer means arranged to be controlled by a terminal user;
a small-size display;
display means arranged to display a portion of a large-size document on the small-size display, the area of the complete large-size document being larger than the area of the small-size display; and
control means arranged to form a miniature copy of the complete large-size document browsed by the browser means,
wherein the display means are arranged to display the miniature copy on the small-size display in the form of a miniature field.

2. The terminal according to claim 1, wherein the display means are arranged to display the miniature copy in such a way that the ratio between the width and height of the miniature copy is equal to the ratio between the width and height of the complete large-size document.

3. The terminal according to claim 1, wherein the pointer means are arranged to point at any position in the miniature field, the control means are arranged to register the position pointed by the pointer means, and the display means are arranged to display on the small-size display an area in the large-size document corresponding to the position pointed by the pointer means.

4. The terminal according to claim 1, wherein the miniature field is movable on the small-size display.

5. The terminal according to claim 1, wherein the display means are arranged to display the miniature field on the small-size display with different transparency levels.

6. The terminal according to claim 1, wherein the size of the miniature field is adjustable.

7. The terminal according to claim 1, wherein the miniature field is scrollable.

8. The terminal according to claim 1, wherein the control means are arranged to position a displayed position field in the miniature field in such a way that the position of the position field in the miniature copy corresponds to the position of the displayed portion of the large-size document in said large-size document.

9. The terminal according to claim 8, wherein the display means are arranged to display the position field in such a way that the ratio between the width and height of the position field is equal to the ratio between the width and height of the displayed portion of the large-size document

10. The terminal according to claim 8, wherein the control means are arranged to move the position field to any other position in the miniature copy by means of the pointer means, the control means are arranged to register the new position of the position field, and the display means are arranged to display on the small-size display the portion of the large-size document corresponding to the new position of the position field.

11. The terminal according to claim 8, wherein the display means are arranged to display the position field on the small-size display with different transparency levels.

12. The terminal according to claim 1, wherein the small-size display is a touch screen.

13. The terminal according to claim 1, wherein the terminal is a telecommunication device.

14. The terminal according to claim 13, wherein the browser means are arranged to browse web pages on the Internet.

15. The terminal according to claim 2, wherein the pointer means are arranged to point at any position in the miniature field, the control means are arranged to register the position pointed by the pointer means, and the display means are arranged to display on the small-size display an area in the large-size document corresponding to the position pointed by the pointer means.

16. The terminal according to claim 2, wherein the miniature field is movable on the small-size display.

17. The terminal according to claim 3, wherein the miniature field is movable on the small-size display.

18. The terminal according to claim 2, wherein the display means are arranged to display the miniature field on the small-size display with different transparency levels.

19. The terminal according to claim 3, wherein the display means are arranged to display the miniature field on the small-size display with different transparency levels.

20. The terminal according to claim 4, wherein the display means are arranged to display the miniature field on the small-size display with different transparency levels.
